(19) United States
(12) Patent Application Publication
(10) Pub. No.: US 2026/0075489 A1
(43) Pub. Date: Mar. 12, 2026

(54) ADAPTIVE PACKET DATA CONVERGENCE PROTOCOL ENTITY MANAGEMENT IN CELL-FREE NETWORKS

(71) Applicant: APPLE INC., Cupertino, CA (US)

(72) Inventors: Ahmed Gamal Helmy Mohamed, Cupertino, CA (US); Danila Zaev, Munich (DE); Ayman F. Naguib, Cupertino, CA (US)

(21) Appl. No.: 19/310,064

(22) Filed: Aug. 26, 2025

Related U.S. Application Data
(60) Provisional application No. 63/693,389, filed on Sep. 11, 2024.

(51) Int. Cl. H04W 36/18; H04W 28/02

(52) U.S. Cl. CPC H04W 36/18; H04W 28/0268

(57) ABSTRACT

Systems and methods for adaptive packet data convergence protocol (PDCP) entity management in wireless communication system implementing a cell-free network are discussed herein. A network identifies a PDCP network level change trigger for a first radio bearer of a UE served by a cluster of base stations, determines, in response to identifying the PDCP network level change trigger for the first radio bearer, to deactivate a first PDCP entity for the first radio bearer that is at a first network level and to activate a second PDCP entity for the first radio bearer at a second network level, instructs the first PDCP entity at the first network level to enter a sleep state, and instructs the second PDCP entity at the second network level to enter an active state. Details about and conditions for the establishment and/or use of PDCP entities at various network levels are discussed.

### TECHNICAL FIELD

This application relates generally to wireless communication systems, including wireless communication systems capable of placing and using packet data convergence protocol entity(s) for a UE radio bearer at various network levels.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

As contemplated by the 3GPP, different wireless communication systems’ standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for an example of clustering in a cell-free network architecture.

FIG. 2 illustrates a diagram showing aspects of radio protocol use in cell-free network mechanisms.

FIG. 3 illustrates a diagram of a Layer 2 architecture using MAC towers in cell-free networks, according to embodiments discussed herein.

FIG. 4A illustrates a diagram for a DU level PDCP entity placement within a wireless communication system for a UE when a UE radio bearer operates through a single DU, according to embodiments discussed herein.

FIG. 4B illustrates a diagram for a DU level PDCP entity placement within a wireless communication system for a UE when a UE radio bearer operates through each of a first DU and a second DU that are connected to each other with a DU-DU interface, according to embodiments discussed herein.

FIG. 4C illustrates a diagram for a CU level PDCP entity placement within a wireless communication system for a UE when a UE radio bearer operates through each of a first DU and a second DU of a same first CU, according to embodiments discussed herein.

FIG. 4D illustrates a diagram for a CU level PDCP entity placement within a wireless communication system for a UE when a UE radio bearer operates through each of a first DU and a second DU of a first CU and through a third DU of a second CU, according to embodiments discussed herein.

FIG. 4E illustrates a diagram for a CN level PDCP entity placement within a wireless communication system for a UE when a UE radio bearer operates through each of a first DU and a second DU of a first CU and through a third DU of a second CU, according to embodiments discussed herein.

FIG. 5 illustrates a diagram for differing (and simultaneous) PDCP entity network level placements within a wireless communication system for a UE when multiple UE radio bearers are in use, according to embodiments discussed herein.

FIG. 6 illustrates a method of a network of a wireless communication system, according to embodiments discussed herein.

FIG. 7 illustrates a method of a first network element of a wireless communication system, according to embodiments discussed herein.

FIG. 8 illustrates a method of a UE, according to embodiments discussed herein.

FIG. 9 illustrates an example architecture of a wireless communication system, according to embodiments disclosed herein.

FIG. 10 illustrates a system for performing signaling between a wireless device and a network device as supported by a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Clustering in Cell-Free Networks

In some wireless communication systems, a cell-free network architecture provides an adaptive/dynamic and UE-centric distribution of functionalities that may be associated with a “serving cell” as understood in the context of prior cell-based network architectures (e.g., such as an NR network architecture or an LTE network architecture). With respect to the present disclosure, it may be understood generally that a “cluster” or “serving cluster” of a UE is a set of physically and/or logically connected base stations over which functionalities related to the serving the UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

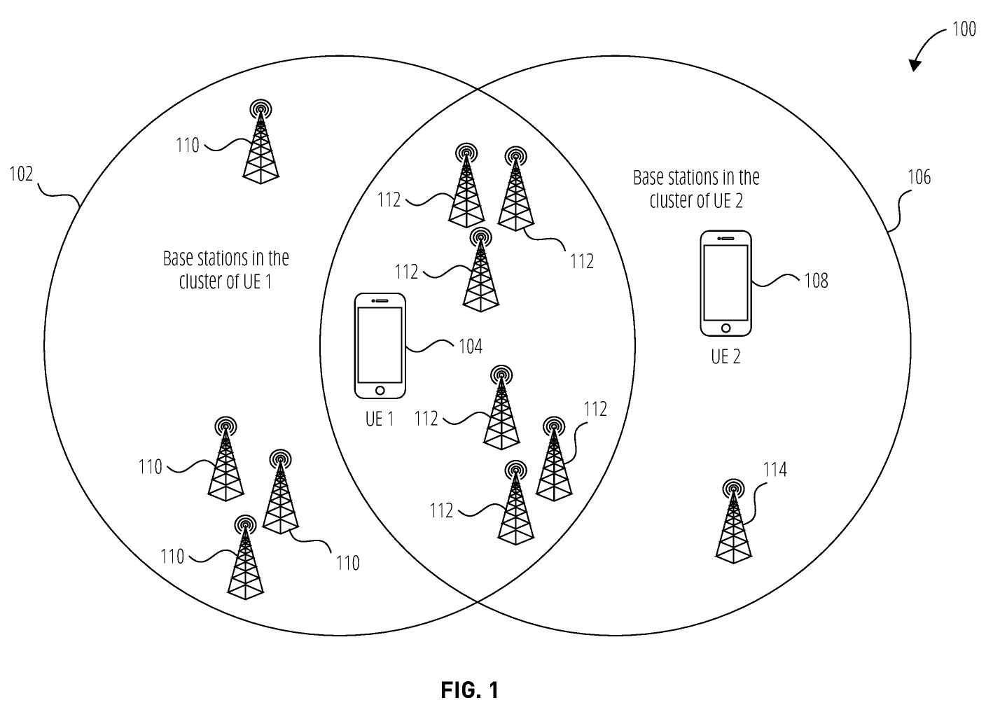

FIG. 1 illustrates a diagram 100 for an example of clustering in a cell-free network architecture. A first cluster 102 of base stations serves a first UE 104 and a second cluster 106 of base stations serves the second UE 108. As illustrated, the first cluster 102 includes the first base stations 110 and the second base stations 112, while the second cluster 106 includes the second base stations 112 and the third base station 114.

Base stations in a same cluster are not necessarily required to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core network(s), a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QoS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE’s initial access). These may include, for example, “greedy”, downlink (DL)-based, uplink (UL)-based, and/or real-time methodologies (and any corresponding message exchanges).

### Radio Protocol in Cell-Free Networks

In some wireless communication systems, “cluster partitioning” represents a radio-bearer-specific dynamic partition of a cluster serving a UE into logical sub-clusters. Such a cluster partitioning into sub-clusters may be determinative of a protocol stack architecture that applies with respect to that cluster. For example, sub-clusters according to the partitioning may be in one-to-one correspondence with radio link control (RLC) entities. Base stations in a same sub-cluster may then, for example, each carry a copy of the same logical RLC entity for a given radio bearer.

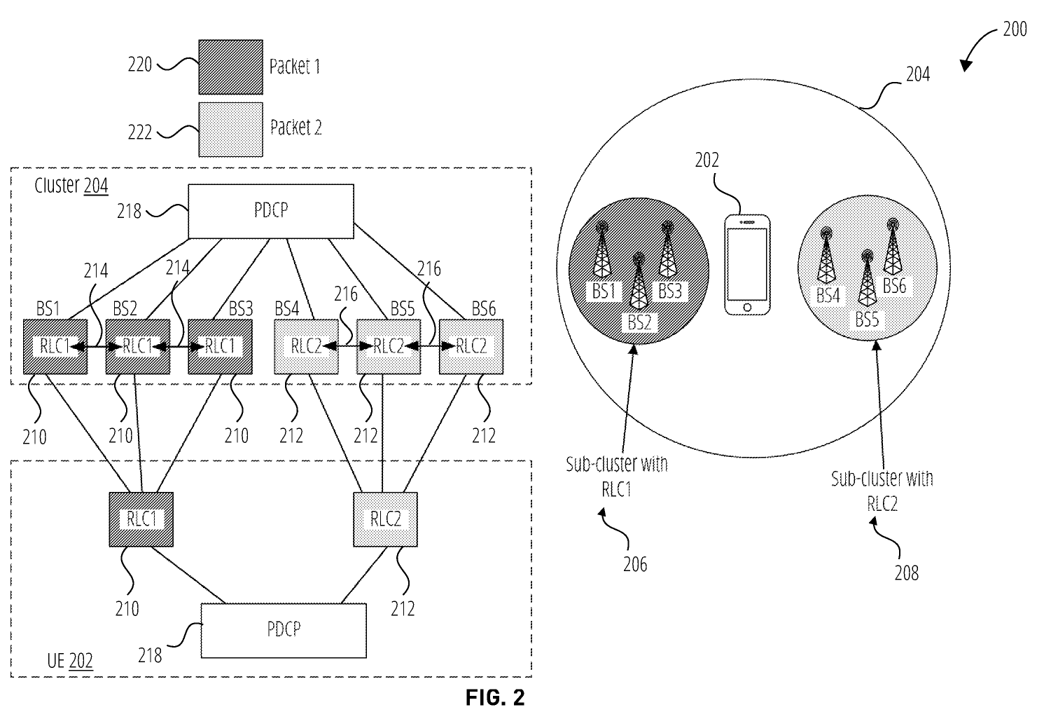

FIG. 2 illustrates a diagram 200 showing aspects of radio protocol use in cell-free network mechanisms. A UE 202 is served by a cluster 204. Within the cluster 204, there is a first sub-cluster 206 that corresponds to a first RLC entity 210 used between the UE 202 and the cluster 204, and a second sub-cluster 208 that corresponds to a second RLC entity 212 between the UE 202 and the cluster 204. The first RLC entity 210 and the second RLC entity 212 are RLC entities used by a PDCP entity 218 that corresponds to a radio bearer between the UE 202 and the cluster 204 and that uses the illustrated cluster partitioning.

As illustrated, the first RLC entity 210 is synchronized 214 across the base stations of the first sub-cluster 206 (“BS1,” “BS2,” and “BS3”). This means that, for example, each of these base stations has and operates according to a copy of the first RLC entity 210, as shown. Further, the second RLC entity 212 is synchronized 216 across the base stations of the second sub-cluster 208 (“BS4,” “BS5,” and “BS6”). This means that, for example, each of these base stations has and operates according to a copy of the second RLC entity 212, as shown. Note that, as illustrated, the arrangement of particular base stations of the cluster into the first sub-cluster 206 or second sub-cluster 208 may be transparent to the UE (the UE knows about/operates in terms of the first RLC entity 210 and the second RLC entity 212 (in terms of the sub-clusters), without consideration with respect to particular base stations underlying those RLC entities/sub-clusters).

In the illustrated case, a first packet 220 of the radio bearer corresponding to the PDCP entity 218 is handled at the first RLC entity 210. This ultimately means that the first packet 220 is communicated between the UE 202 and the cluster 204 via one or more of the base stations of the first sub-cluster 206. Further, a second packet 222 of the (same) radio bearer corresponding to the PDCP entity 218 is handled at the second RLC entity 212. This ultimately means that the second packet 222 is communicated between the UE 202 and the cluster 204 via one or more of the base stations of the second sub-cluster 208.

It is contemplated that a cluster partitioning may be updated over time. Establishment and/or updating of a cluster partitioning may take into account QoS requirements and traffic properties associated with a radio bearer. For example, latency constraints, and/or traffic periodicity may be considered. These mechanisms allow the network (e.g., a CCF) to optimally configure sub-cluster-enabled multi-connectivity of a UE to a cluster in, for example, a non-ideal backhaul scenario (where different partitionings of a same cluster may have appreciably different QoS/traffic management characteristics).

In some wireless communication systems, radio protocols in cell-free networks utilize concepts such as cluster partitioning/sub-clusters, RLC synchronization, etc. A functionality for control over dynamically updating cluster partitions, and a corresponding protocol for the update procedure may be used. PDCP data routing options and a corresponding configuration may be used. Finally, a cell-free radio bearer configuration and/or a message exchange procedure for radio bearer establishment may be used.

### Example Layer 2 Architecture using Medium Access Control (MAC) Towers in Cell-Free Networks

In some embodiments, a set of MAC entities can be configured as a “MAC tower” when the MACs have a single common base station and/or when the MACs are connected with the same set of RLC entities. In certain such embodiments, a MAC entity belongs to a single MAC tower, MAC entities of the same MAC tower are physically implemented at the same shared base station, MAC entities of the same MAC tower may coordinate their grant allocation decisions with each other in real time, different MAC towers may provide grants without real-time synchronization with each other, MAC entities of the same MAC tower share the same hybrid automatic repeat request (HARQ) processes, and/or MAC towers at the network side and MAC entities at UE side are in a one-to-one correspondence.

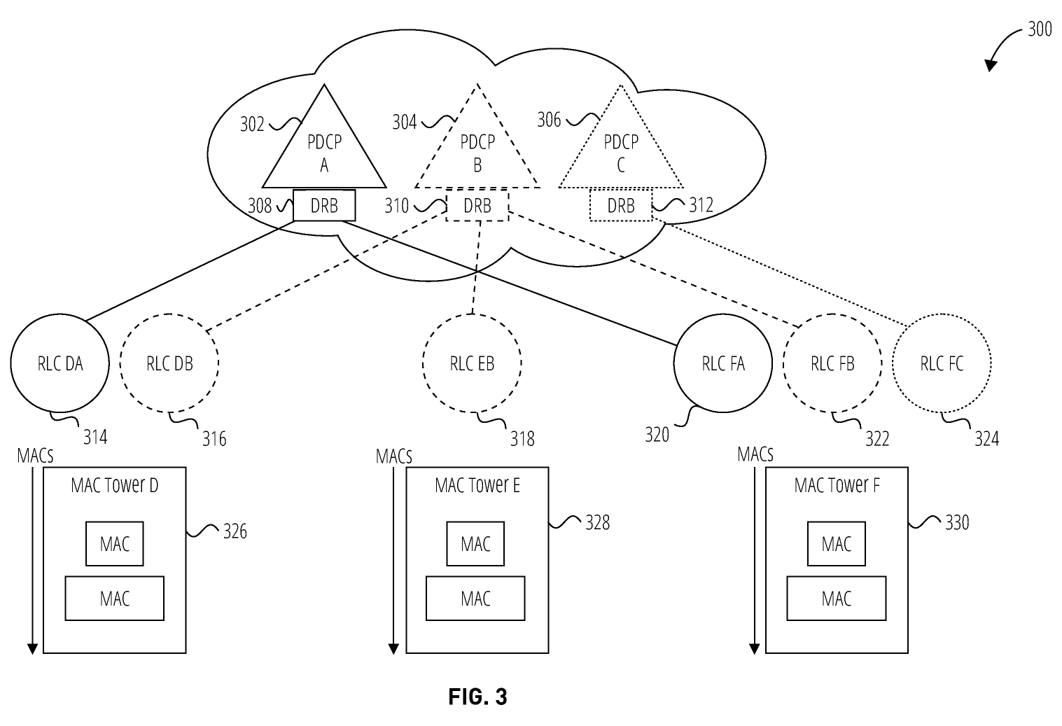

FIG. 3 illustrates a diagram 300 of a Layer 2 architecture using MAC towers in cell-free networks, according to embodiments discussed herein. In the illustrated example, which is from a network perspective, a first PDCP entity 302 (“PDCP A”), a second PDCP entity 304 (“PDCP B”), and a third PDCP entity 306 (“PDCP C”) are implemented close to a user plane function (not shown), following similar re-allocation procedures (e.g., 5G session and service continuity procedures). As illustrated, the first PDCP entity 302 is associated with a first data radio bearer (DRB) 308, the second PDCP entity 304 is associated with a second DRB 310, and the third PDCP entity 306 is associated with the third DRB 312. Forward error correction (FEC) coding and/or erasure coding may be implemented at the PDCP layer on top of multiple wireless links.

As shown, each PDCP entity (and its associated DRB) may be configured with multiple RLC entities. In the illustrated example, the first PDCP entity 302 is configured with a first RLC entity 314 for MAC tower D 326 (“RLC DA”) and a second RLC entity 320 for MAC tower F 330 (“RLC FA”). Similarly, the second PDCP entity 304 is configured with a third RLC entity 316 for MAC tower D 326 (“RLC DB”), a fourth RLC entity 318 for MAC tower E 328 (“RLC EB”), and a fifth RLC entity 322 for MAC tower F 330 (“RLC FB”). Further, in this example, the third PDCP entity 306 is configured with a sixth RLC entity 324 for MAC tower F 330 (“RLC FC”). A many-to-many relationship for RLC entities may be established when a Layer 2 protocol stack is configured or reconfigured. For DRBs with low-latency requirements, RLCs are typically configured in a transparent mode (TM) or an unacknowledged mode (UM).

Each MAC tower may have a single MAC entity counterpart at the UE side, and HARQ processes may be implemented on a per-MAC-tower basis. An RLC buffer can be created for a pair of (DRB, MAC tower). The RLC buffer and its associated MAC tower may reside at the same base station to allow for low latency communications. In certain embodiments, a copy of the RLC buffer is available at each base station of a max set of the associated MAC tower (where the max set is a maximum set of base stations in a cluster that can be used by the MAC tower for resource allocation).

### Terminology

For purposes of this disclosure, a distributed unit (DU) of a cell-free network may refer to any network node that operates as an air interface entity. Accordingly, it will be understood that a DU, as discussed herein for cell-free networks, is a concept that may cover a scope that is different than that of a “distributed unit” as understood in some previously existing contexts (e.g., a DU as discussed herein may be understood at least somewhat differently than the concept of a 5G “distributed unit” as currently defined in 3GPP specifications).

Similarly, for purposes of this disclosure, a centralized unit (CU) of a cell-free network may refer to any network node that operates as a cloud entity. Accordingly, it will be understood that a CU, as discussed herein for cell-free networks, is a concept that may cover a scope that is different than that of a “centralized unit” as understood in some previously existing contexts (e.g., a CU as discussed herein may be understood at least somewhat differently than the concept of a 5G “centralized unit” as currently defined in 3GPP specifications).

It will be understood that functionalities of “base stations” as discussed herein may be split across CUs and DUs within the applicable RAN.

It will also be understood that, for purposes of various embodiments of cell-free network deployments, a UE can connect simultaneously to multiple DUs (via multiple TRPs), which may be managed by either a same CU or by different CUs.

Further, for purposes of this disclosure, a PDCP entity may be or include any protocol stack entity that performs the functionalities of packet sequencing, packet reordering, automatic retransmission request (ARQ), packet header compression/decompression, ciphering/de-ciphering, packet duplication, packet steering, uplink reassembly, downlink segmentation, and/or downlink buffering.

### PDCP Placement in 5G Networks

In various wireless communication systems, the placement of PDCP entities plays a role in ensuring efficient data processing, integrity, and confidentiality. PDCP functionalities may include header compression and encryption, which are used to maintain data integrity and security.

For 5G-based wireless communication systems, there are primarily two possible configuration options for the placement of PDCP entities. In a first configuration option, the PDCP entity is located at a (5G) centralized unit. In this configuration, PDCP functionality, along with RRC functionality, is centralized at the centralized unit. This approach benefits from centralized coordination and management, allowing for easier scalability and streamlined control over multiple (5G) distributed units. However, it demands a robust F1 interface to manage communication between the centralized unit and the distributed units, which can introduce latency challenges.

In a second configuration option, the PDCP entity is located at a (5G) distributed unit. In this configuration, PDCP functionality is implemented at the distributed unit level, closer to the RLC, MAC, and PHY layers. This placement minimizes latency by maintaining direct communication paths between the distributed unit and its associated radio unit(s) (RU(s)). This configuration may be particularly effective in cases where a UE is connected to a single distributed unit or when the latency of inter-distributed-unit communication is within acceptable limits. However, it can be less flexible when dealing with multiple distributed units, especially when those distributed units are managed by different (5G) centralized units.

Note that in current in-field 5G deployments, the static placement of PDCP entities within the 5G centralized unit is the widely adopted approach. While this static assignment simplifies network design, it poses significant challenges in dynamic and distributed architectures (such as architectures for the cell-free networks discussed herein).

### PDCP Entity Placement in Cell-Free Networks

It has been determined that the static placement of a PDCP entity within a cell-free network faces various drawbacks. For example, cell-free networks use dynamic UE connections where a UE can connect simultaneously to multiple DUs (via multiple transmission reception points (TRPs)). These multiple DUs may be managed by either the same CU and/or different CUs, as the case may be. The use of a static PDCP placement under such dynamic circumstances can complicate user plane data management, requiring advanced/particularized handling to support seamless mobility of the UE.

Another example drawback is seen when considering intra-CU and inter-CU mobility that may occur within cell-free networks. For this context, it will be noted that effective management of mobility, both within and across CUs, is called for in order to minimize service interruptions. Static PDCP placement complicates this management, especially when UEs interact across DUs and CUs without direct interfaces. This can result in potential disruptions and increased latency during mobility of the UE.

Another example drawback is seen when considering service continuity and latency aspects of cell-free networks. Ensuring minimal service disruptions during PDCP entity transition is called for in cell-free networks. The static placement of PDCP entities may not be sufficient in environments with rapid changes in UE connectivity (as may be the case in cell-free networks), leading to potential latency issues and degraded network performance. Dynamic and adaptive PDCP management may therefore be applied in order to address these challenges and maintain high QoS.

Given the aforementioned challenges, embodiments discussed herein relate to mechanisms for the use of dynamic PDCP management, placement, and use in cell-free network contexts.

For example, various embodiments herein illustrate mechanisms for comparatively seamless transitions for intra-CU and inter-CU mobility. For each radio bearer of a UE, one or more PDCP entities may be established/used at various network levels on an as-needed basis, enabling mobility by the UE without any need to completely re-establish protocol stack entities therefore. This transition may represent a minimal disruption to a user plane data session, thereby aligning with the zero-latency goals of a cell-free network architecture.

Correspondingly, various embodiments herein describe the support for different operational or network levels. For different radio bearers of a UE, the corresponding PDCP entities support (can be operated at) various network levels that depend on PDCP entity placement within the protocol stack. For example, a PDCP entity for a UE radio bearer may be placed at a DU to operate at a DU level, at a CU to operate at a CU level, or at a core network (CN) to operate at a CN level. This flexibility accommodates different distributed protocol stack architectures associated with different radio bearers. This flexibility can also ensure that each radio bearer receives an optimal QoS with minimized latency and service disruptions.

Wireless communication systems according to cell-free network embodiments discussed herein may, for a given UE-centric cluster of base stations, support three different options for PDCP entity establishment/placement. In a first option, a PDCP entity may be established/used at a DU (at a DU level). In a second option, a PDCP entity may be established/used at a CU (at a CU level). In a third option, a PDCP entity may be established/used at a CN (at a CN level).

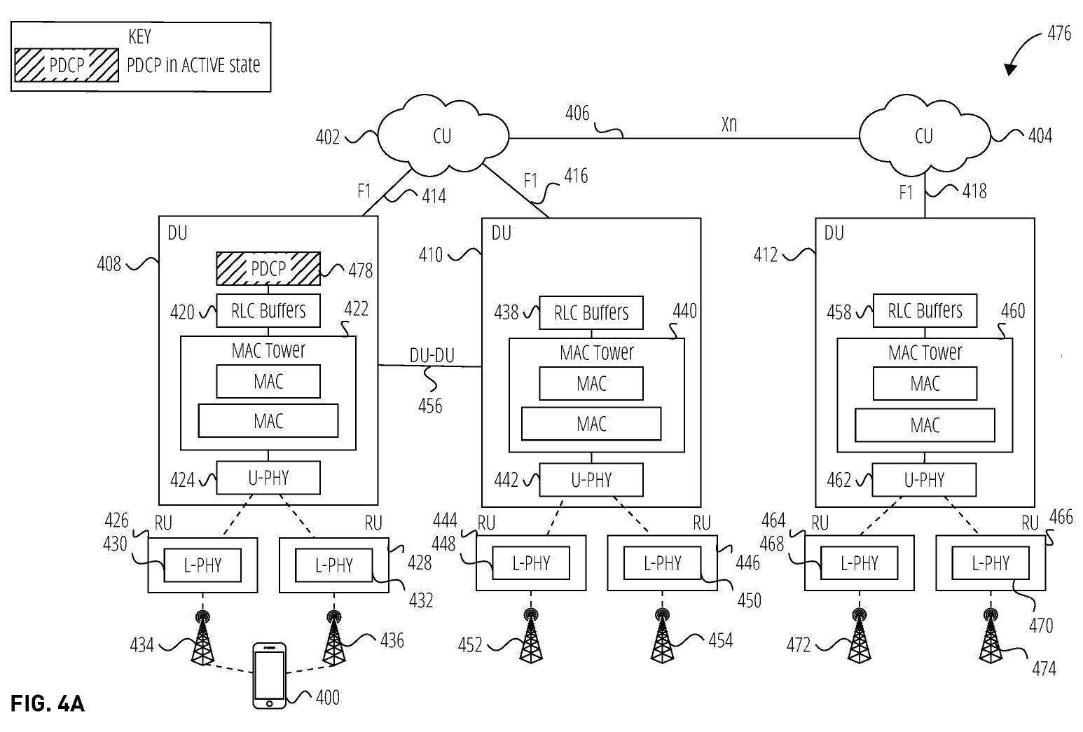

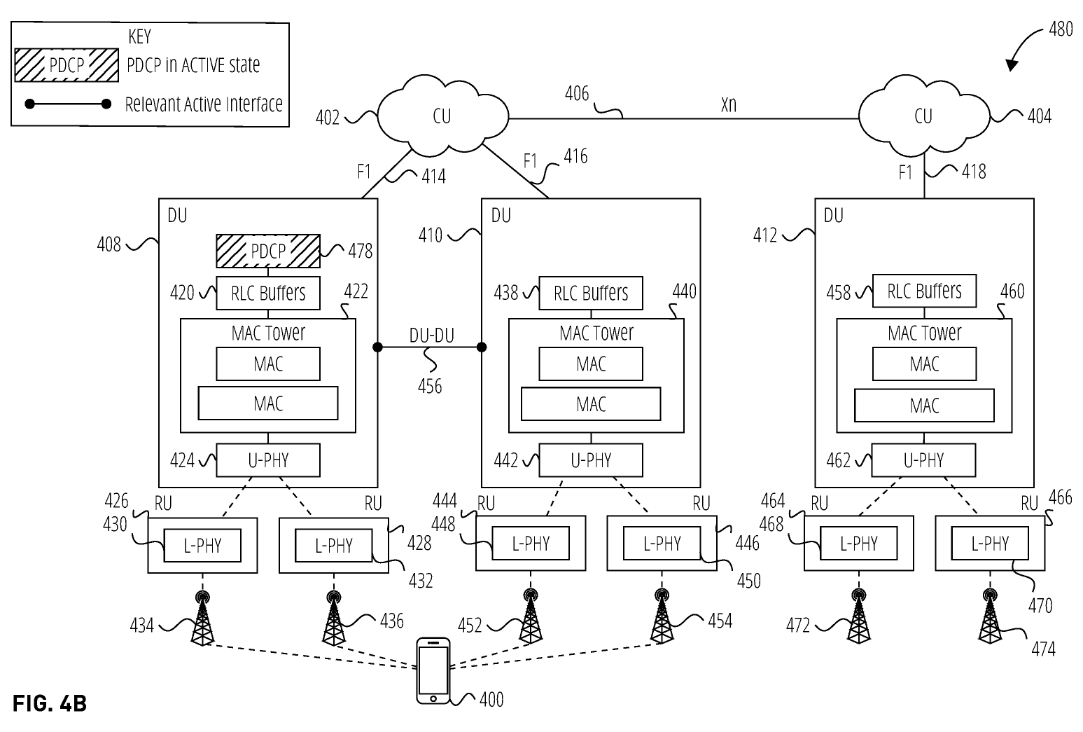

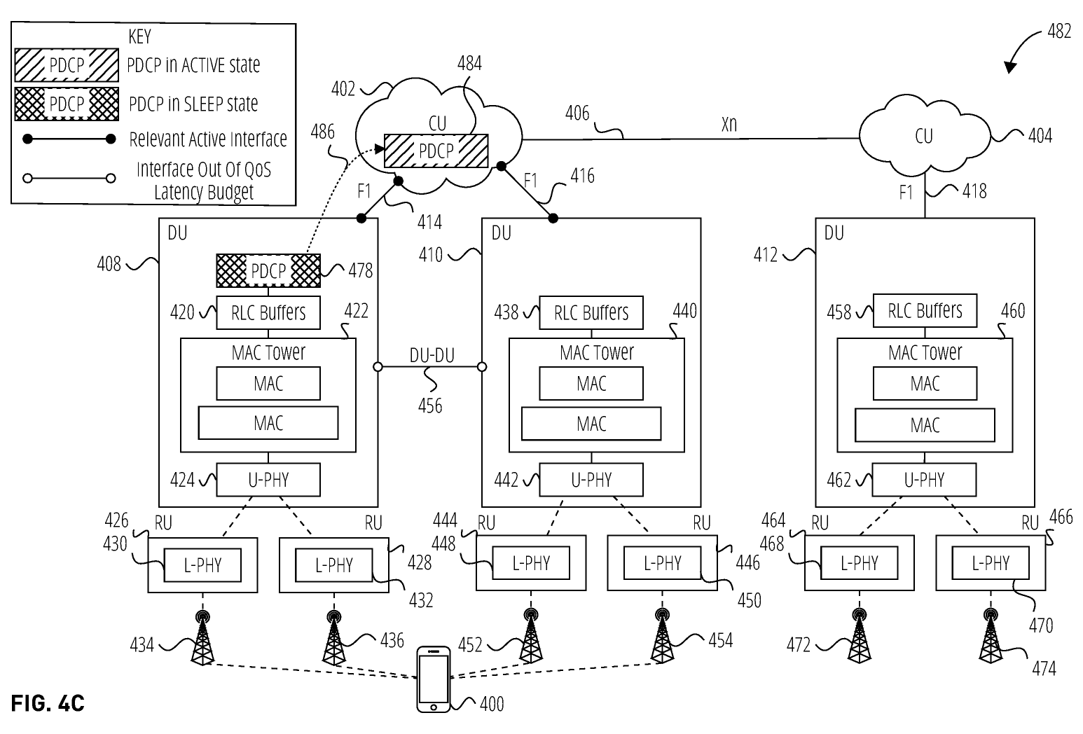

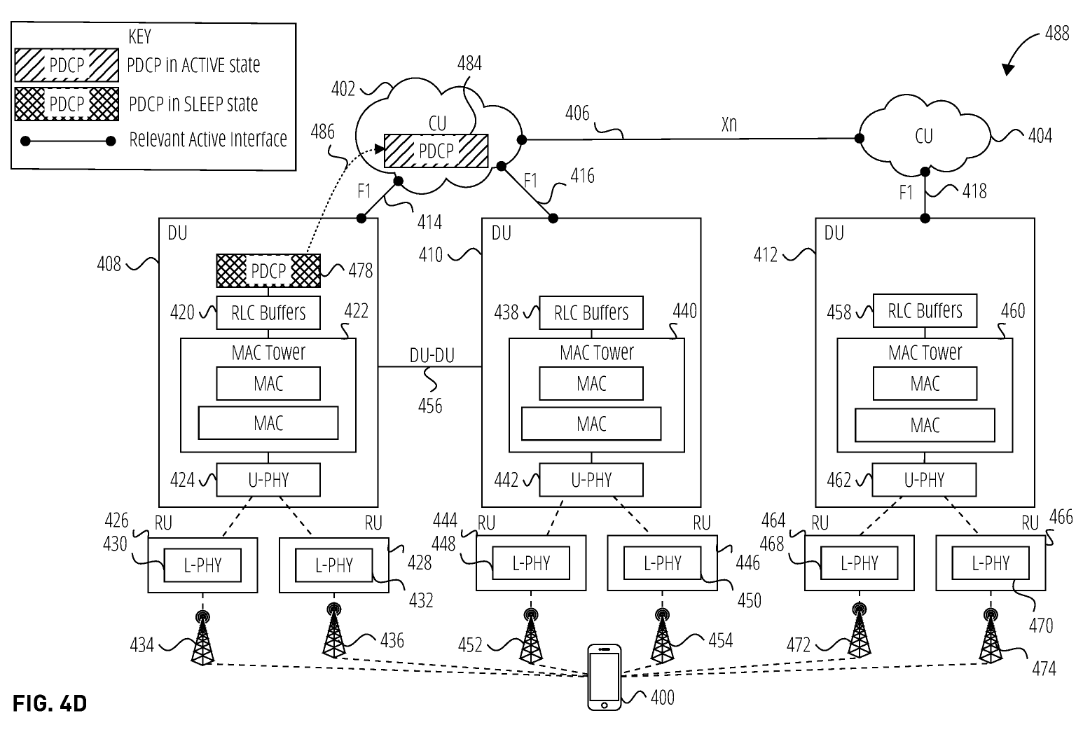

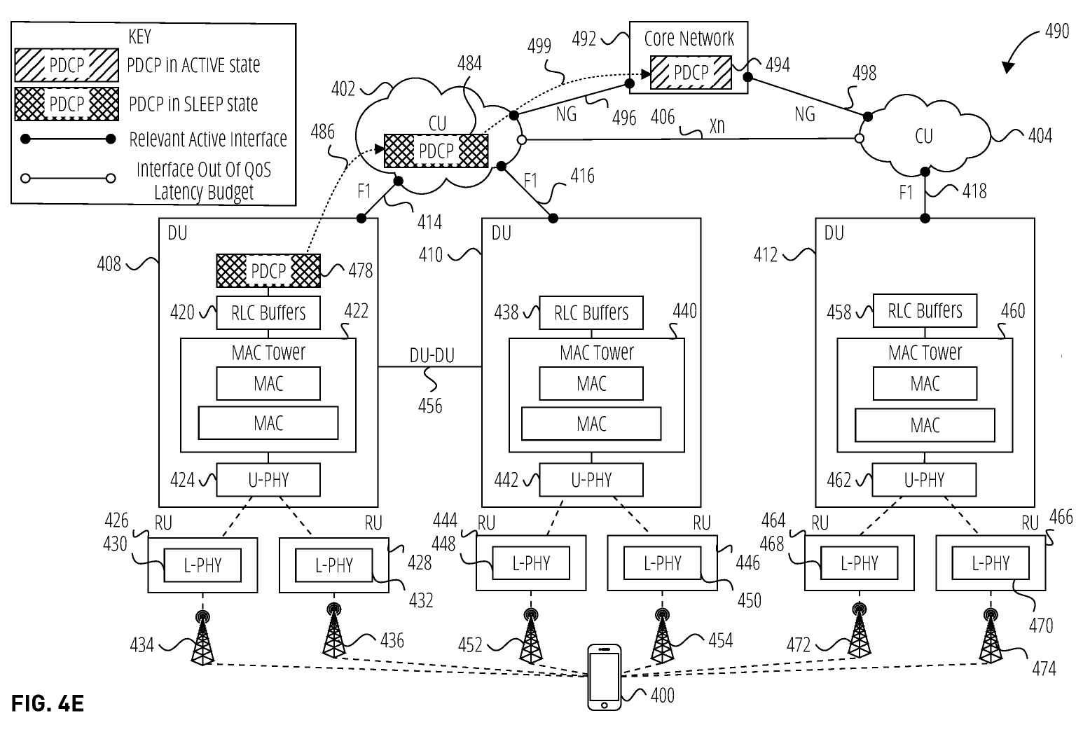

Embodiments illustrating various example cases among these options are now discussed in relation to FIGS. 4A through 4E.

In some embodiments, a PDCP entity is established/used at a DU level. This may be the case when a UE radio bearer is connected to either a single DU or to multiple DUs under the same CU that are directly connected via a low-latency DU-DU interface (also referred to herein as a DU to DU interface) that facilitates the use of the PDCP entity at the DU level.

FIG. 4A illustrates a diagram 476 for a DU level PDCP entity placement within a wireless communication system for a UE 400 when a UE radio bearer operates through a single DU (the first DU 408), according to embodiments discussed herein.

The diagram 476 illustrates that the system includes a first CU 402 and a second CU 404 connected by an Xn interface 406. Further, a first DU 408 is connected to the first CU 402 via a first F1 interface 414, a second DU 410 is (also) connected to the first CU 402 via a second F1 interface 416, and a third DU 412 is connected to the second CU 404 via a third F1 interface 418.

The first DU 408 includes first RLC buffers 420, a first MAC tower 422, and a first U-PHY entity 424. The first U-PHY entity 424 is used to connect the first DU 408 to each of the first RU 426 and the second RU 428. The first RU 426 includes a first L-PHY entity 430 that interfaces with a first TRP 434 used by the first DU 408. The second RU 428 includes a second L-PHY entity 432 that interfaces with a second TRP 436 used by the first DU 408.

The second DU 410 includes second RLC buffers 438, a second MAC tower 440, and a second U-PHY entity 442. The second U-PHY entity 442 is used to connect the second DU 410 to each of the third RU 444 and the fourth RU 446. The third RU 444 includes a third L-PHY entity 448 that interfaces with a third TRP 452 used by the second DU 410. The fourth RU 446 includes a fourth L-PHY entity 450 that interfaces with a fourth TRP 454 used by the second DU 410.

As illustrated, the first DU 408 and the second DU 410 may be connected via a DU-DU interface 456 between the first DU 408 and the second DU 410.

The third DU 412 includes third RLC buffers 458, a third MAC tower 460, and a third U-PHY entity 462. The third U-PHY entity 462 is used to connect the third DU 412 to each of the fifth RU 464 and the sixth RU 466. The fifth RU 464 includes a fifth L-PHY entity 468 that interfaces with a fifth TRP 472 used by the third DU 412. The sixth RU 466 includes a sixth L-PHY entity 470 that interfaces with a sixth TRP 474 used by the third DU 412.

It is noted that various ones of the network-side elements of FIG. 4A as just described are used in each of FIG. 4A through FIG. 4E (and thus will not be re-described in relation to FIG. 4B through FIG. 4E).

As illustrated in the diagram 476, the UE 400 is understood to connect to the network through the first DU 408 (e.g., via the first TRP 434 and the second TRP 436 used by the first DU 408). The diagram 476 illustrates a case for PDCP entity placement when a bearer of the UE 400 accordingly connects with the network through the first DU 408 (e.g., via the first TRP 434 and the second TRP 436 used by the first DU 408) and does not connect to the network through either of the second DU 410 or the third DU 412. In this case, a first PDCP entity 478 is established/actively used at the first DU 408, as illustrated.

FIG. 4B illustrates a diagram 480 for a DU level PDCP entity placement within a wireless communication system for a UE 400 when a UE radio bearer operates through each of a first DU 408 and a second DU 410 that are connected to each other with a DU-DU interface 456, according to embodiments discussed herein.

As illustrated in the diagram 480, the UE 400 is now understood to connect to the network through each of the first DU 408 (e.g., via the first TRP 434 and the second TRP 436 used by the first DU 408) and the second DU 410 (e.g., via the third TRP 452 and the fourth TRP 454 used by the second DU 410). The first PDCP entity 478 that is located at the first DU 408 can accordingly actively operate a UE radio bearer across both the first DU 408 and the second DU 410 by leveraging the DU-DU interface 456. This is achievable in the case that the DU-DU interface 456 is of a low enough latency that the use of inter-DU communication between the first DU 408 and the second DU 410 for purposes of using the first PDCP entity 478 at the first DU 408 for the UE radio bearer can be accomplished within the constraints of any quality of service (QoS) requirement(s) for the bearer. Accordingly, the diagram 480 notates that the DU-DU interface 456 is a “relevant active interface” in this circumstance.

In cases where a PDCP entity operates at a DU level, control of the corresponding PDCP configuration may be handled by radio resource control (RRC) messaging.

The operation of a PDCP entity at a DU level has various advantages. For example, operation of the PDCP entity at the DU minimizes latency by maintaining direct communication paths between the DU and applicable RU(s). Further, when used in cases where multiple DUs are used by the UE radio bearer and where PDCP aspects are coordinated across a DU-DU interface between the multiple DUs, a DU-based PDCP entity enables localized PDCP management, thereby optimizing response times and reducing overhead.

The operation of a PDCP entity at a DU level may be associated with one or more limitations in some circumstances. For example, the operation of a PDCP entity at a DU level may not be suitable for scenarios where a UE’s bearer spans multiple DUs that lack a low-latency DU-DU interface between them. This case may call for higher network level PDCP coordination.

In some embodiments, a PDCP entity is established/used at a CU level. This may be the case when, for example, when a UE radio bearer connects to multiple DUs under the same CU, and where there is no relevant DU-DU interface or where coordination through an available DU-DU interface surpasses QoS requirement thresholds for the UE radio bearer. Placement/use of a PDCP entity at the CU level may also be used when the UE radio bearer connects through DUs of multiple CUs different CUs in cases where inter-CU latency via Xn and F1 interfaces remains within acceptable limits to keep PDCP at the CU level.

FIG. 4C illustrates a diagram 482 for a CU level PDCP entity placement within a wireless communication system for a UE 400 when a UE radio bearer operates through each of a first DU 408 and a second DU 410 of a same first CU 402, according to embodiments discussed herein.

As illustrated in the diagram 482, the UE 400 is understood to connect to the network through each of the first DU 408 (e.g., via the first TRP 434 and the second TRP 436 used by the first DU 408) and the second DU 410 (e.g., via the third TRP 452 and the fourth TRP 454 used by the second DU 410). There may accordingly be a corresponding UE radio bearer that connects across both the first DU 408 and the second DU 410.

In this case, it may be understood that the DU-DU interface 456 is not useable for supporting the use of the first PDCP entity 478 with the UE radio bearer as in the example of FIG. 4B, because this use would not meet a QoS requirement for the UE radio bearer. Accordingly, in FIG. 4C, the DU-DU interface 456 has been indicated as an “interface out of QoS latency budget.”

Note that this case is analogous to an alternative possible case where there is no DU-DU interface 456 between the first DU 408 and the second DU 410 in the first instance.

As sufficient inter-DU coordination is not possible between the separate DUs through which the UE radio bearer is connected, the establishment/use of a second PDCP entity 484 at the first CU 402 is called for, in the manner illustrated in FIG. 4C. Once established and active, the second PDCP entity 484 performs PDCP entity behaviors for the UE radio bearer using communications with the first DU 408 over the first F1 interface 414 and with the second DU 410 over the second F1 interface 416. Accordingly, each of the first F1 interface 414 and the second F1 interface 416 have been indicated as “relevant active interfaces” in FIG. 4C.

FIG. 4C also shows an example of dynamic PDCP entity placement/use. For example, it may be that the UE previously used the first PDCP entity 478 at the first DU 408 (e.g., as described in relation to FIG. 4A and/or FIG. 4B). Then, the network for a cluster serving the UE 400 may identify a PDCP network level change trigger associated with the use of the second PDCP entity 484 at the first CU 402 instead of the first PDCP entity 478 at the first DU 408.

As one example of such a PDCP network level change trigger, it may be that the UE 400 has transitioned from the use of (only) the first DU 408 for the UE radio bearer (as in FIG. 4A) to the use of both the first DU 408 and the second DU 410 for the UE radio bearer.

As another example of such a PDCP network level change trigger, it may be that an existing DU-DU interface 456 between the first DU 408 and the second DU 410 cannot meet an applicable QoS requirement for the UE radio bearer (e.g., a DU-DU interface 456 as so used in the case described in FIG. 4B has degraded and can no longer meet the applicable QoS requirement(s)).

In response to such a PDCP network change trigger, the system performs a transition 486 from the use of the first PDCP entity 478 at the first DU 408 for the UE radio bearer to the use of the second PDCP entity 484 at the first CU 402 for the UE radio bearer. For example, the network may send the first PDCP entity 478 at the first DU 408 an instruction to enter a SLEEP state, as illustrated. Further, the network may establish the second PDCP entity 484 (if not already present at the first CU 402) and/or send the second PDCP entity 484 an instruction to enter an ACTIVE state.

It will be understood that the inverse procedure could also occur, according to corresponding inverse PDCP network level change triggers. For example, take a case where the bearer of the UE 400 is operated by the second PDCP entity 484 through each of the first DU 408 and the second DU 410 as illustrated in FIG. 4C. Then, the network for the cluster serving the UE 400 may identify a PDCP network level change trigger associated with the use of the first PDCP entity 478 at the first DU 408 instead of the second PDCP entity 484 at the first CU 402.

As one example of such a PDCP network level change trigger, it may be that the UE 400 transitions to the use of (only) the first DU 408 for the radio bearer (as in FIG. 4A) from the use of both the first DU 408 and the second DU 410 for the radio bearer as illustrated herein FIG. 4C.

As another example of such a PDCP network level change trigger, it may be that the DU-DU interface 456 between the first DU 408 and the second DU 410 is determined to be able to meet applicable QoS requirements for the UE radio bearer (e.g., the DU-DU interface 456 as used in the case of FIG. 4C improves and can now meet the applicable QoS requirement(s)).

In response to such a PDCP network change trigger, the system may transition from the use of the second PDCP entity 484 at the first CU 402 for the UE radio bearer to the use of the first PDCP entity 478 at the first DU 408 for the UE radio bearer. For example, the network may send the second PDCP entity 484 at the first CU 402 an instruction to enter a SLEEP state. Further, the network may establish the first PDCP entity 478 at the first DU 408 (if not already present at the first DU 408) and/or send the first PDCP entity 478 an instruction to enter an ACTIVE state. Note that this is essentially the inverse procedure to the transition 486 illustrated in relation to FIG. 4C.

FIG. 4D illustrates a diagram 488 for a CU level PDCP entity placement within a wireless communication system for a UE 400 when a UE radio bearer operates through each of a first DU 408 and a second DU 410 of a first CU 402 and through a third DU 412 of a second CU 404, according to embodiments discussed herein.

As illustrated in the diagram 488, the UE 400 is now understood to connect to the network through each of the first DU 408 (e.g., via the first TRP 434 and the second TRP 436 used by the first DU 408), the second DU 410 (e.g., via the third TRP 452 and the fourth TRP 454 used by the second DU 410), and the third DU 412 (e.g., via the DU-DU interface 456 and the third RLC buffers 458 used by the third DU 412). There may accordingly be a corresponding UE radio bearer that connects across all of the first DU 408, the second DU 410, and the third DU 412.

The second PDCP entity 484 that is located at the first CU 402 can actively operate for the UE radio bearer with respect to the first DU 408 and the second DU 410 across the first F1 interface 414 and the second F1 interface 416. Further, the second PDCP entity 484 can (also) actively operate for the UE radio bearer with respect to the second CU 404/the third DU 412 by leveraging the Xn interface 406 and the third F1 interface 418. This is achievable in the case that the latency of the use of PDCP related communications through the Xn interface 406 is not in violation of QoS requirements for the UE radio bearer. Accordingly, the diagram 488 notates that each of the first F1 interface 414, the second F1 interface 416, the Xn interface 406, and the third F1 interface 418 is a “relevant active interface” in this circumstance.

FIG. 4D also shows an example of dynamic PDCP entity placement/use. For example, it may be that the UE previously used the first PDCP entity 478 at the first DU 408 (e.g., as described in relation to FIG. 4A and/or FIG. 4B). Then, the network for the cluster serving the UE 400 identifies a PDCP network level change trigger associated with the use of the second PDCP entity 484 at the first CU 402 instead of the first PDCP entity 478 at the first DU 408.

As one example of such a PDCP network level change trigger, it may be that the UE 400 has transitioned from the use of one or both of the first DU 408 and the second DU 410 for the radio bearer (as in FIG. 4A or FIG. 4B) to the use of the one or both of the first DU 408 and/or the second DU 410 in addition to the third DU 412 for the radio bearer.

In response to such a PDCP network change trigger, the system performs a transition 486 from the use of the first PDCP entity 478 at the first DU 408 for the UE radio bearer to the use of the second PDCP entity 484 at the first CU 402 for the UE radio bearer. For example, the network may send the first PDCP entity 478 at the first DU 408 an instruction to enter a SLEEP state, as illustrated. Further, the network may establish the second PDCP entity 484 (if not already present at the first CU 402) and/or send the second PDCP entity 484 an instruction to enter an ACTIVE state.

It will be understood that the inverse procedure could also occur, according to corresponding inverse PDCP network level change triggers. For example, take a case where the bearer of the UE 400 is operated by the second PDCP entity 484 through each of the first DU 408, the second DU 410, and the third DU 412 as illustrated in FIG. 4C. Then, a network entity (e.g., a CCF) for the cluster serving the UE 400 may identify a PDCP network level change trigger associated with the use of the first PDCP entity 478 at the first DU 408 instead of the second PDCP entity 484 at the first CU 402.

As one example of such a PDCP network level change trigger, it may be that the UE 400 has transitioned from the use of one or both of first DU 408 and the second DU 410 for the radio bearer in addition to the third DU 412 for the radio bearer (e.g., all three of the first DU 408, the second DU 410, and the third DU 412 as illustrated in FIG. 4D) to the use of (only) one or both of the first DU 408 and/or the second DU 410 (e.g., as illustrated in FIG. 4A or FIG. 4B).

In response to such a PDCP network change trigger, the system may transition from the use of the second PDCP entity 484 at the first CU 402 for the UE radio bearer to the use of the first PDCP entity 478 at the first DU 408 for the UE radio bearer. For example, the network may send the second PDCP entity 484 at the first CU 402 an instruction to enter a SLEEP state. Further, the network may establish the first PDCP entity 478 at the first DU 408 (if not already present at the first DU 408) and/or send the first PDCP entity 478 an instruction to enter an ACTIVE state. Note that this is essentially the inverse procedure to the transition 486 illustrated in relation to FIG. 4D.

In cases where a PDCP entity operates on a CU level, control of the corresponding PDCP configuration may be handled by RRC control messaging.

The operation of a PDCP entity on a CU level has various advantages. For example, the CU level placement provides for more centralized user plane management, facilitates better resource allocation and synchronization of services across multiple DUs, optimizes response times, and reduces overhead when UE mobility is contained within the coverage of same CU or closely connected (for bearer QoS purposes) CUs.

The operation of a PDCP entity at a CU level may be associated with one or more limitations in some circumstances. For example, such an arrangement may be less effective when connectivity involves multiple CUs that are connected through high-latency Xn interfaces. This case may call for higher network level PDCP coordination.

In some embodiments, a PDCP entity is established/used at a CN level. This may be the case when, for example, connectivity for a UE radio bearer extends across DUs that are under different CUs and the latency incurred through the applicable Xn and F1 interfaces for managing PDCP using a PDCP entity at the CU level (e.g., as in FIG. 4D) does not meet QoS requirements and/or when NG interface latency as between the CN and the different CUs offers a better alternative compared to the accumulated latency of Xn interface(s) between the different CUs.

FIG. 4E illustrates a diagram 490 for a CN level PDCP entity placement within a wireless communication system for a UE 400 when a UE radio bearer operates through each of a first DU 408 and a second DU 410 of a first CU 402 and through a third DU 412 of a second CU 404, according to embodiments discussed herein.

The diagram 490 illustrates that each of the first CU 402 and the second CU 404 is connected to a CN 492. The first CU 402 connects to the CN 492 via a first NG interface 496 and the second CU 404 connects to the CN 492 via a second NG interface 498.

As illustrated in the diagram 490, the UE 400 is understood to connect to the network through each of the first DU 408 (e.g., via the first TRP 434 and the second TRP 436 used by the first DU 408), the second DU 410 (e.g., via the third TRP 452 and the fourth TRP 454 used by the second DU 410), and the third DU 412 (e.g., via the fifth TRP 472 and the sixth TRP 474 used by the third DU 412). There may accordingly be a corresponding UE radio bearer that connects across all of the first DU 408, the second DU 410, and the third DU 412.

The third PDCP entity 494 that is located at the CN 492 can actively operate for a UE radio bearer with respect to the first DU 408 across the first NG interface 496 and the first F1 interface 414, can actively operate for the UE radio bearer with respect to the second DU 410 across the first NG interface 496 and the second F1 interface 416, and can actively operate for the UE radio bearer with respect to the third DU 412 across the second NG interface 498 and the third F1 interface 418. Accordingly, the diagram 490 notates that each of the first F1 interface 414, the second F1 interface 416, the first NG interface 496, the second NG interface 498, and the third F1 interface 418 is a “relevant active interface” in this circumstance.

Note that in the case illustrated in FIG. 4E, latency aspects for the Xn interface 406 are too high to enable the active use of the second PDCP entity 484 in the event that, as here, the UE radio bearer uses one and/or both of the first DU 408 and the second DU 410 in addition to the third DU 412 (e.g., as in FIG. 4D). Accordingly, the diagram 490 notates that the Xn interface 406 is a “interface out of QoS latency budget” in this circumstance.

FIG. 4E also shows an example of dynamic PDCP entity placement/use. For example, it may be that the UE previously used the second PDCP entity 484 at the first CU 402 (e.g., as described in relation to FIG. 4C and/or FIG. 4D). Then, a network entity (e.g., a CCF) for the cluster serving the UE 400 may identify a PDCP network level change trigger associated with the use of the third PDCP entity 494 at the CN 492 instead of the second PDCP entity 484 at the first CU 402.

As one example of such a PDCP network level change trigger, it may be that the UE 400 has transitioned from the use of one or both of first DU 408 and the second DU 410 for the radio bearer (as in FIG. 4C) to the use of the one or both of the first DU 408 and/or the second DU 410 in addition to the third DU 412 for the radio bearer.

As another example of such a PDCP network level change trigger, it may be that an inability of any existing Xn interface 406 between the first CU 402 and the second CU 404 to meet an applicable QoS requirement for the UE radio bearer is identified (e.g., an Xn interface 406 as so used in the case described in FIG. 4D has degraded and can no longer meet the applicable QoS requirement(s)).

In response to such a PDCP network change trigger, the system performs a transition 499 from the use of the second PDCP entity 484 at the first CU 402 for the UE radio bearer to the use of the third PDCP entity 494 at the CN 492 for the UE radio bearer. For example, the network may send the second PDCP entity 484 at the first CU 402 an instruction to enter a SLEEP state, as illustrated. Further, the network may establish the third PDCP entity 494 (if not already present at the CN 492) and/or send the third PDCP entity 494 an instruction to enter an ACTIVE state.

It will be understood that the inverse procedure could also occur, according to corresponding inverse PDCP network level change triggers. For example, take a case where the bearer of the UE 400 is operated by the third PDCP entity 494 through each of the first DU 408, the second DU 410, and the third DU 412 as illustrated in FIG. 4E. Then, a network entity (e.g., a CCF) for the cluster serving the UE 400 may identify a PDCP network level change trigger associated with the use of the second PDCP entity 484 at the first CU 402 instead of the third PDCP entity 494 at the CN 492.

As one example of such a PDCP network level change trigger, it may be that the UE 400 has transitioned from the use of one or both of first DU 408 and the second DU 410 for the radio bearer, in addition to the third DU 412 for the radio bearer (as in FIG. 4E) to the use of the one or both of the first DU 408 and/or the second DU 410 (e.g., as in FIG. 4C).

As another example of such a PDCP network level change trigger, it may be that an ability of an existing Xn interface 406 between the first CU 402 and the second CU 404 to meet an applicable QoS requirement for the UE radio bearer is identified (e.g., an Xn interface 406 as so used in the case described in FIG. 4D improves and can now meet the applicable QoS requirement(s)).

In response to such a PDCP network change trigger, the system may transition from the use of the third PDCP entity 494 at the CN 492 for the UE radio bearer to the use of the second PDCP entity 484 at the first CU 402 for the UE radio bearer. For example, the network may send the third PDCP entity 494 at the CN 492 an instruction to enter a SLEEP state. Further, the network may establish the second PDCP entity 484 at the first CU 402 (if not already present at the first CU 402) and/or send the second PDCP entity 484 an instruction to enter an ACTIVE state. Note that this is essentially the inverse procedure to the transition 499 illustrated in relation to FIG. 4E.

In cases where a PDCP entity operates on a CN level, control of the corresponding PDCP configuration may be handled similarly to that for user plane function (UPF) control.

The operation of a PDCP entity on a CN level has various advantages. For example, the CN level placement centralizes control near the UPF (or integrates control for UPF with control of PDCP configuration such that control for the PDCP configuration is similar to UPF control), minimizes overall system latency, and enhances the management of user sessions across relatively broader network areas than the cases of DU level or CU level PDCP entity operation. The operation of a PDCP entity on a CN level may be called for in order to efficiently manage complex topologies and/or high-mobility scenarios.

The operation of a PDCP entity at a CN level may be associated with one or more limitations in some circumstances. For example, while CN level PDCP entity operation offers the greatest flexibility and control relative to DU level and CU level control, this approach may introduce relatively more overhead and/or latency (due to centralized processing demands), meaning that the CN level PDCP entity placement/use may be less favorable in the context of some low-latency applications.

Corresponding to embodiments disclosed herein, it is contemplated that a given UE-centric cluster may support multiple radio bearers for the UE (each having different/independent QoS requirement(s)). It is accordingly beneficial for the network to support concurrent uses of PDCP entities for each of these multiple radio bearers at different (or at least independently determined) hierarchical network levels (DU level, CU level, and/or CN level), based on DUs used for each radio bearer and/or the QoS requirements of each radio bearer.

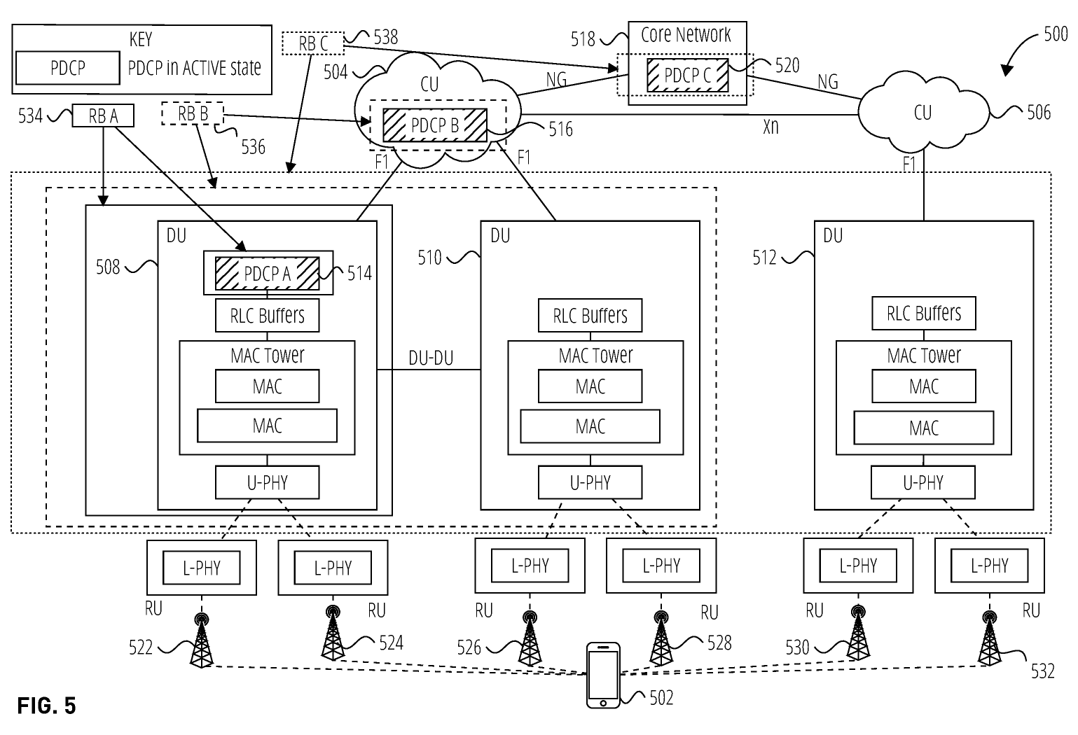

FIG. 5 illustrates a diagram 500 for differing (and simultaneous) PDCP entity network level placements within a wireless communication system for a UE 502 when multiple UE radio bearers are in use, according to embodiments discussed herein. While the reference number markup of FIG. 5 has been simplified as compared to that used in FIG. 4A through FIG. 4E, note that various ones of the elements illustrated in the FIG. 5 may be analogous to those as explained in relation to FIG. 4A through FIG. 4E.

As illustrated in the diagram 500, the UE 502 is understood to connect to the network through each of the first DU 508 (e.g., via the first TRP 522 and the second TRP 524 used by the first DU 508), the second DU 510 (e.g., via the third TRP 526 and the fourth TRP 528 used by the second DU 510), and the third DU 512 (e.g., via the fifth TRP 530 and the sixth TRP 532 used by the third DU 512).

The diagram 500 illustrates the use of a first PDCP entity 514 (“PDCP A”) serving a first radio bearer 534 (“RB A”). It may be that the first radio bearer 534 requires ultralow latency. Accordingly, the first radio bearer 534 is localized at the DU level (connects to the network through (only) the first DU 508, as illustrated) to leverage direct DU to RU communications. Accordingly, the PDCP entity for the first radio bearer 534 (the first PDCP entity 514) is established/used at the first DU 508.

The diagram 500 also illustrates the use of a second PDCP entity 516 (“PDCP B”) serving a second radio bearer 536 (“RB B”). The second radio bearer 536 spans across/connects to the network through each of the first DU 508 and the second DU 510 as these are operated by the first CU 504, as illustrated. Accordingly, the PDCP entity for the second radio bearer 536 (the second PDCP entity 516) is established/used at the CU level (at the first CU 504) to optimize inter-DU coordination and resource management.

The diagram 500 also illustrates the use of a third PDCP entity 520 (“PDCP C”) serving a third radio bearer 538 (“RB C”). The third radio bearer 538 spans across/connects to the network through each of the first DU 508 and the second DU 510 (as operated by the first CU 504) and the third DU 512 (as operated by the second CU 506). Accordingly, the PDCP entity for the third radio bearer 538 (the third PDCP entity 520) is established/used at the CN 518 where it can effectively handle correspondingly broader mobility patterns and complex network topologies.

Note that each of the first PDCP entity 514, the second PDCP entity 516, and/or the third PDCP entity 520 may individually participate in transitions to/from other PDCP entities for their corresponding UE radio bearer, as these processes are discussed elsewhere herein.

### PDCP Entity Signatures

PDCP entities discussed herein may correspond to PDCP signatures. A PDCP signature may be understood as a unique identifying set of attributes assigned to (or at least initialized at) a PDCP entity upon its creation. This signature encompasses a set of data that is specific to the operational environment of the PDCP entity.

One purpose of a PDCP signature is to enable seamless mobility support by facilitating the smooth and rapid transition between PDCP entities for a given UE radio bearer across diverse network nodes, optimizing mobility management in dynamic cell-free network architectures.

A PDCP signature may be generated when a PDCP entity is first created for a specific radio bearer. The use of the PDCP signature may be unique to the one or more PDCP entity(s) created for that particular UE radio bearer. This ensures that each bearer associated with the UE has/corresponds to a distinct PDCP signature reflecting its individual settings and requirements.

A PDCP signature may include and/or indicate one or more attributes. In some embodiments, a PDCP signature includes/indicates configuration data for settings and parameters of the PDCP entity, such as compression settings and/or a protocol version used.

In some embodiments, a PDCP signature includes/indicates a PDCP identifier (ID). The PDCP ID may represent details useable by a service data application protocol (SDAP) entity to route data with respect to the PDCP entity.

In some embodiments, a PDCP signature includes a UE ID. A UE ID may encapsulate the identity of the UE associated with the PDCP entity (the UE having the UE radio bearer for the PDCP entity), linking the PDCP entity to its user and ensuring correct and secure handling of user data.

In some embodiments, a PDCP signature includes one or more security contexts. These security contexts may contain UE-specific security related information, including encryption algorithms.

### PDCP Entity States

A PDCP entity state may be understood as an operational placement status for a PDCP entity. The PDCP entity state determines/relates to a PDCP entity’s level of activity and/or resource utilization in the network for given UE cluster. Embodiments herein discuss the use of two such PDCP entity states, an ACTIVE state and a SLEEP state.

An ACTIVE state for a PDCP entity may be understood as an operational PDCP placement state that indicates that the PDCP entity is fully operational. In the ACTIVE state, the PDCP entity is actively handling data transmission and reception for the corresponding UE radio bearer. The PDCP entity may accordingly engage in one or more PDCP entity functions including header compression, ciphering, integrity protection, reordering, etc., to maintain seamless and efficient data flow for the UE radio bearer.

A SLEEP state for a PDCP entity may be understood as an operational PDCP placement state that signifies a low-activity mode for the PDCP entity. In the SLEEP state, the PDCP entity conserves resources by reducing its operational activities, allowing the network to optimize resource usage while keeping the PDCP entity ready for quick reactivation.

Various embodiments discussed herein relate to cases where a single UE radio bearer can be supported at various different times by various different PDCP entities sited at different network levels. Corresponding to such cases, it is anticipated that a single PDCP entity for the UE radio bearer at a time should be in ACTIVE state, while any other PDCP entities for the UE radio bearer (e.g., at other network levels) should be in a SLEEP state during that same time.

### Signature-based Adaptive PDCP Entity Management Functionalities

Various functionalities for signature-based adaptive PDCP entity management are now provided. These functionalities may use/relate to a PDCP signature that is used for PDCP entity(s) of a given UE radio bearer.

In some embodiments, a PDCP entity duplication functionality is supported. This functionality may be used to duplicate a first PDCP entity for a UE radio bearer at a first network level into a second PDCP entity for the UE radio bearer at a second network level.

First, the PDCP signature for the first PDCP entity is referenced. The PDCP signature for the first PDCP entity is used to identify and reference the first PDCP entity’s configurations, PDCP ID, and/or security contexts. Then, the second PDCP entity is established using the information identified from the signature of the first PDCP entity. The second PDCP entity thus mirrors the first PDCP entity’s parameters and state.

In some embodiments, a PDCP security context update functionality is supported. This functionality may be used to ensure that a security context for the PDCP entity is updated and communicated to the UE, such that the security context remains useful to maintain data confidentiality and integrity.

First, new security parameters are generated for the PDCP entity. For example, new encryption keys and/or integrity protection keys for the PDCP entity are generated. Then, the UE is notified of this updated security context, thereby ensuring that the UE is synchronized with the security context for the PDCP entity.

The PDCP security context update may be performed for a PDCP entity when, for example, the PDCP entity is newly established for the corresponding network level (among other times).

In some embodiments, activation and sleep transition functionality is supported. This functionality may be used to transition a PDCP entity to an ACTIVE state and/or a SLEEP state.

For example, it may be that a UE radio bearer previously served by a first PDCP entity at a first network level is to be served instead by a second PDCP entity at a second network level. In such circumstances, the activation and sleep transition functionality may be used for PDCP activation purposes to instruct the second PDCP entity at the second network level to enter the ACTIVE state, making it the primary handler for data transmission and reception. Further, this functionality may additionally instruct the first PDCP entity at the first network level to enter the SLEEP state, reducing its activity to conserve resources while maintaining a state of readiness for potential reactivation.

In some embodiments, a periodic update functionality is supported. This functionality may be used to maintain any SLEEP state PDCP entities for a UE radio bearer in a state of readiness and/or to maintain data integrity aspects of the SLEEP state PDCP entities.

For example, it may be that an ACTIVE state PDCP entity for the UE radio bearer periodically synchronizes with the SLEEP state PDCP entity(s) for the UE radio bearer, such that a consistent data state between the ACTIVE PDCP entity and the SLEEP PDCP entity(s) is maintained.

As another example, the periodic update functionality may be used to conduct periodic checks to confirm that SLEEP state PDCP entity(s) for a UE radio bearer are ready for potential reactivation (thereby ensuring minimal latency if reactivation is needed). In other words, this functionality may be used to verify that the SLEEP PDCP entity(s) is/are indeed synchronized with the ACTIVE state PDCP entity.

### Control Messaging for Adaptive PDCP Entity Use

In some embodiments, various control messages may be used within the wireless communication system in order to facilitate PDCP entity use.

A first example of such a control message is a key update message. This message may be sent by the network element (e.g., a CU, a DU, or a CN entity) having a PDCP entity in an ACTIVE mode to a UE of the UE radio bearer corresponding to the PDCP entity. The key update message may include, for example, one or more of: new/updated encryption keys for securing data of the UE radio bearer, new/updated integrity protection keys for ensuring data integrity of the UE radio bearer, and/or an updated PDCP signature for the PDCP entity reflecting a new security context. Use of the key update message may be intended to inform the UE of the updated keys and/or an updated PDCP signature for purposes of maintaining secure communication on the UE radio bearer.

A second example of such a control message is a PDCP signature and security context update message. This message may be sent by the network element (e.g., a CU, a DU, or a CN entity) having a PDCP entity for a UE radio bearer in an ACTIVE state to another network element having a PDCP entity for the UE radio bearer in a SLEEP state. The PDCP signature and security context update message may include, for example, one or more of: an updated PDCP entity signature corresponding to the UE radio bearer to ensure a consistent security context exists across all PDCP entities for the UE; updated security parameters, such as new encryption and/or integrity keys, reflecting a new security context; and/or an operational status that indicates that the PDCP entity is in the ACTIVE state and/or that the receiving PDCP entity should use the SLEEP state. Use of the PDCP signature and security context update message may be intended to ensure all relevant network nodes are updated with any new PDCP signature and security context information (e.g., in the case where a new PDCP entity has been established and activated) and/or to synchronize the security context of any PDCP entity(s) for a UE radio bearer in a SLEEP state to that of a PDCP entity for the UE radio bearer in the ACTIVE state to prepare for potential future reactivation.

### UE Security Context Sets

In some embodiments, a UE maintains a set of security contexts (SCS) for a UE radio bearer. As discussed herein, the network can configure several PDCP entities (one in an ACTIVE state, the others in a SLEEP state) for the UE radio bearer. These various PDCP entities for the UE radio bearer may be configured for use with different security contexts from the SCS of the UE.

Consistent with this operation, various control messages for UE SCS maintenance are contemplated. A first example of a control message for UE SCS maintenance is a message that is used to add a PDCP entity’s security context to the SCS of the UE. In this case, the sender of the message is a network element (e.g., a CU, a DU, or a CN entity) of a network that has multiple PDCP entities configured for a given radio bearer of the UE, and the receiver of the message is the UE. This message may indicate a new additional security context for the SCS, which may include one or more of: additional encryption key(s), additional integrity protection key(s), and/or security parameters for the UE radio bearer.

A second example of a control message for UE SCS maintenance is a message that is used to remove a PDCP security context from the SCS of the UE. In this case, the sender of the message is a network element (e.g., a CU, a DU, or a CN entity) and the receiver is a UE. This message may indicate an ID of a security context in the SCS of the UE that should be removed.

A third example of a control message for UE SCS maintenance is a message that is used to activate a PDCP security context from the SCS of the UE. In this case, the sender of the message is a network element (e.g., a CU, a DU, or a CN entity) of a network that has multiple PDCP entities configured for a given radio bearer of the UE, and the receiver of the message is the UE. This message may indicate a security context (e.g., using a security context ID) from the SCS of the UE to activate. The message may be intended for use in the case where the network activates (transitions from SLEEP state to ACTIVE state) a new PDCP entity with a new/different security context such that the UE is informed to activate/switch to the corresponding security context from the SCS. Note that in cases where more than one security context is active at the UE, it is anticipated that the UE might try to apply the security contexts to downlink (DL) data in consecutive way. It is anticipated for such cases that uplink (UL) data may use the newly activated security context.

A fourth example of a control message for UE SCS maintenance is a message that is used to deactivate a PDCP security context of the SCS of the UE. In this case, the sender of the message is a network element (e.g., a CU, a DU, or a CN entity) of a network that has multiple PDCP entities configured for a given radio bearer of the UE, and the receiver of the message is the UE. This message may indicate an ID of a security context in the SCS of the UE that should be deactivated, such that the UE deactivates that security context.

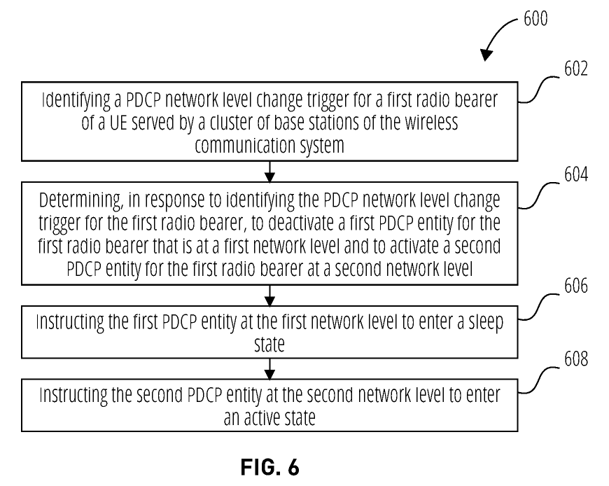

FIG. 6 illustrates a method 600 of a network of a wireless communication system, according to embodiments discussed herein. The method 600 includes identifying 602 a PDCP network level change trigger for a first radio bearer of a UE served by a cluster of base stations of the wireless communication system. The method 600 further includes determining 604, in response to identifying the PDCP network level change trigger for the first radio bearer, to deactivate a first PDCP entity for the first radio bearer that is at a first network level and to activate a second PDCP entity for the first radio bearer at a second network level. The method 600 further includes instructing 606 the first PDCP entity at the first network level to enter a sleep state. The method 600 further includes instructing 608 the second PDCP entity at the second network level to enter an active state.

In some embodiments, the method 600 further includes determining that the second PDCP entity has not yet been established at the second network level; and duplicating the first PDCP entity into the second PDCP entity at the second network level. In some such embodiments, duplicating the first PDCP entity into the second PDCP entity comprises: identifying PDCP signature attributes of a PDCP signature for the first PDCP entity; and establishing the second PDCP entity using the PDCP signature attributes of the PDCP signature for the first PDCP entity. In some of these cases, the PDCP signature attributes comprise one or more of: configuration data for the first PDCP entity; a PDCP entity identifier for the first PDCP entity; a UE identifier for the UE; and a PDCP security context for the first PDCP entity.

In some embodiments of the method 600, the first network level comprises DU level and the first PDCP entity resides at a first DU of the cluster that is used by the first radio bearer; and the second network level comprises a CU level and the second PDCP entity resides at a CU of the cluster. In some such embodiments, the PDCP network level change trigger comprises that the UE has connected to a second DU of the cluster that is used by the first radio bearer. In some such embodiments, the PDCP network level change trigger comprises that a latency of a DU to DU interface between the first DU and a second DU of the cluster that is used by the first radio bearer does not meet a QoS requirement for the first radio bearer.

In some embodiments of the method 600, the first network level comprises a CU level and the first PDCP entity resides at a CU of the cluster that is used by the first radio bearer; and the second network level comprises a DU level and the second PDCP entity resides at a first DU of the cluster. In some such embodiments, the PDCP network level change trigger comprises that the UE has disconnected from a second DU of the cluster that is used by the first radio bearer. In some such embodiments, the PDCP network level change trigger comprises that a latency of a DU to DU interface between the first DU and a second DU of the cluster that is used by the first radio bearer does meets a QoS requirement for the first radio bearer.

In some embodiments of the method 600, the first network level comprises a CU level and the first PDCP entity resides at a first CU of the cluster that is used by the first radio bearer; and the second network level comprises a CN level and the second PDCP entity resides at a CN of the wireless communication system. In some such embodiments, the PDCP network level change trigger comprises that the UE has connected to a second DU of the cluster that is used by the first radio bearer. In some such embodiments, the PDCP network level change trigger comprises that a that a latency of an Xn interface between the first CU and a second CU of the cluster that is used by the first radio bearer does not meet a QoS requirement for the first radio bearer.

In some embodiments of the method 600, the first network level comprises a CN level and the first PDCP entity resides at a CN of the wireless communication system; and the second network level comprises a CU level and the second PDCP entity resides at a first CU of the cluster. In some such embodiments, the PDCP network level change trigger comprises that the UE has disconnected from a second DU of the cluster that is used by the first radio bearer. In some such embodiments, the PDCP network level change trigger comprises that a that a latency of an Xn interface between the first CU and a second CU of the cluster that is used by the first radio bearer meets a QoS requirement for the first radio bearer.

In some embodiments, the method 600 further includes operating a third PDCP entity for a second radio bearer for the UE at another network level from the second network level while operating the second PDCP entity for the first radio bearer at the second network level.

In some embodiments, the method 600 further includes establishing a new PDCP security context for the second PDCP entity that is different than an existing PDCP security context for the first PDCP entity; and sending the new PDCP security context for the second PDCP entity to the UE.

In some embodiments, the method 600 further includes synchronizing, after instructing the first PDCP entity at the first network level to enter the sleep state, the first PDCP entity with the second PDCP entity.

In some embodiments, the method 600 further includes verifying, after instructing the first PDCP entity at the first network level to enter the sleep state, whether the first PDCP entity remains synchronized with the second PDCP entity.

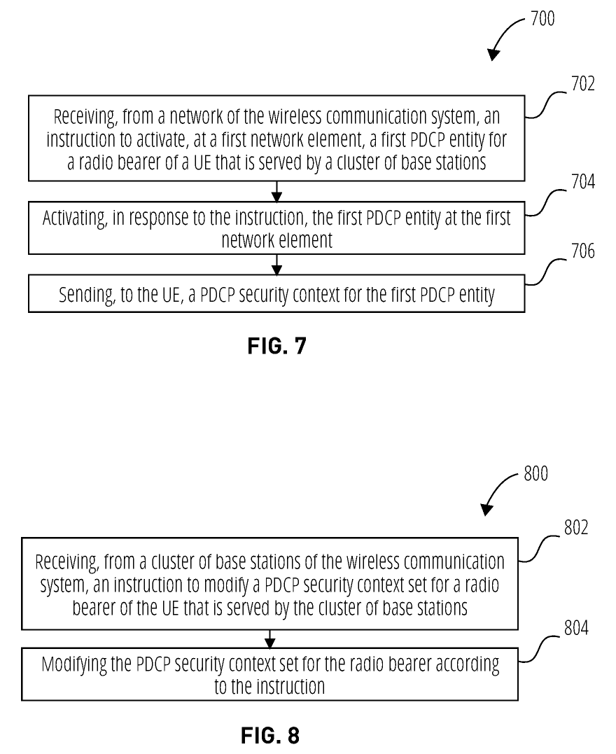

FIG. 7 illustrates a method 700 of a first network element of a wireless communication system, according to embodiments discussed herein. The method 700 includes receiving 702, from a network of the wireless communication system, an instruction to activate, at the first network element, a first PDCP entity for a radio bearer of a UE that is served by a cluster of base stations. The method 700 further includes activating 704, in response to the instruction, the first PDCP entity at the first network element. The method 700 further includes sending 706, to the UE, a PDCP security context for the first PDCP entity.

In some embodiments of the method 700, the PDCP security context for the first PDCP entity comprises one or more of: an encryption key; an integrity key; and a PDCP signature for the first PDCP entity.

In some embodiments, the method 700 further includes sending, to a second network element, the PDCP security context for the first PDCP entity.

In some embodiments, the method 700 further includes sending, to a second network element, a PDCP signature for the first PDCP entity.

In some embodiments, the method 700 further includes sending, to a second network element, an indication that the first PDCP entity is in an active state.

In some embodiments, the method 700 further includes sending, to a second network element, an indication that a second PDCP entity for the radio bearer that is at the second network element is in a sleep state.

In some embodiments of the method 700, the first network element comprises one or more of: a distributed unit (DU); a centralized unit (CU); and a core network (CN) entity.

FIG. 8 illustrates a method 800 of a UE, according to embodiments discussed herein. The method 800 includes receiving 802, from a cluster of base stations of the wireless communication system, an instruction to modify a PDCP security context set for a radio bearer of the UE that is served by the cluster of base stations. The method 800 further includes modifying 804 the PDCP security context set for the radio bearer according to the instruction.

In some embodiments of the method 800, the instruction instructs the UE to add a PDCP security context to the PDCP security context set; and the UE modifies the PDCP security context set by adding the PDCP security context to the PDCP security context set.

In some embodiments of the method 800, the instruction instructs the UE to remove a PDCP security context from the PDCP security context set; and the UE modifies the PDCP security context set by removing the PDCP security context from the PDCP security context set.

In some embodiments of the method 800, the instruction instructs the UE to activate a PDCP security context of the PDCP security context set; and the UE modifies the PDCP security context set by activating the PDCP security context.

In some embodiments of the method 800, the instruction instructs the UE to deactivate a PDCP security context of the PDCP security context set; and the UE modifies the PDCP security context set by deactivating the PDCP security context.

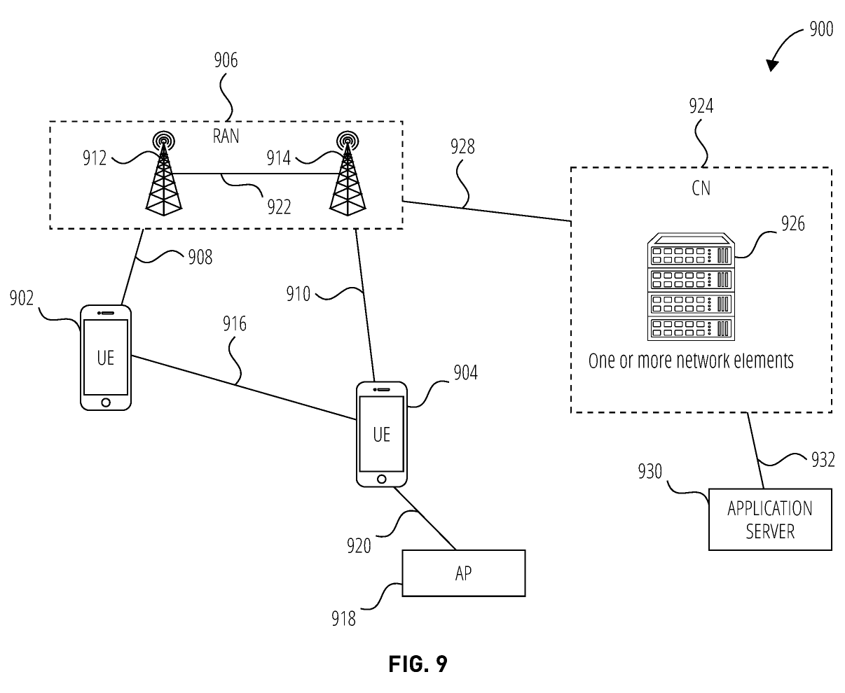

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi^{®} router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

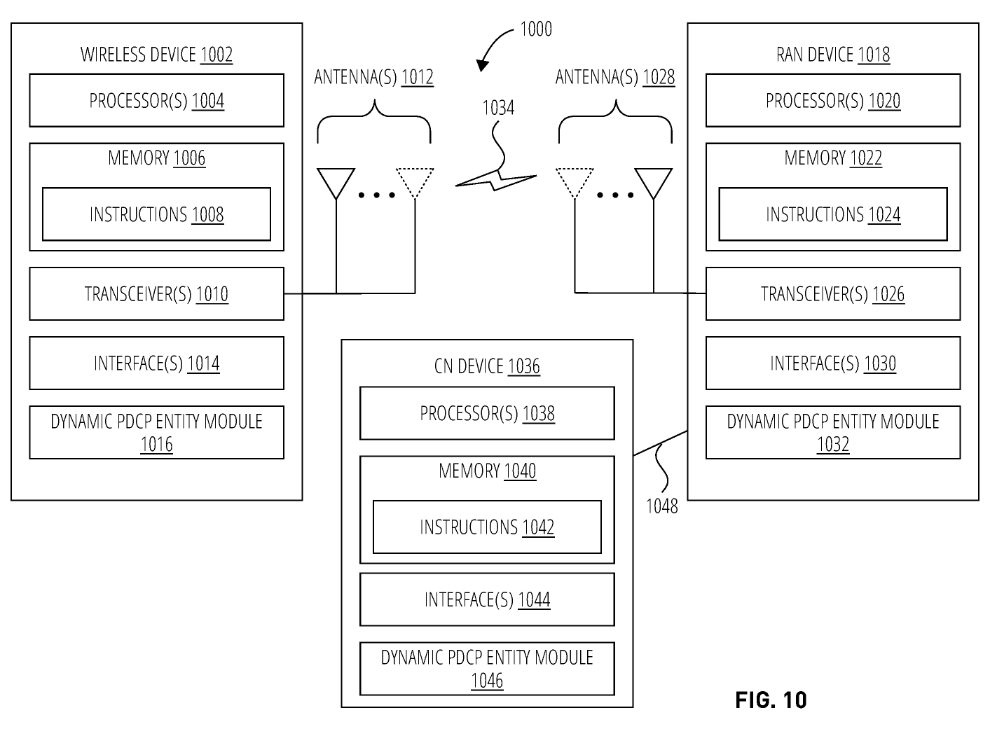

FIG. 10 illustrates a system 1000 for performing signaling 1034 between a wireless device 1002 and a RAN device 1018 as supported by a CN device 1036, according to embodiments disclosed herein. The system 1000 may be a portion of a wireless communications system as herein described. The wireless device 1002 may be, for example, a UE of a wireless communication system. The RAN device 1018 may be, for example, a base station (e.g., an eNB, a gNB, or a sixth generation base station) or a part of a base station (e.g., a CU or a DU) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter circuitry and/or receiver circuitry that use the antenna(s) 1012 of the wireless device 1002 to facilitate signaling (e.g., the signaling 1034) to and/or from the wireless device 1002 with other devices (e.g., the RAN device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/ antenna(s) 1012 already described) that allow for communication between the UE and other devices and may operate according to known protocols (e.g., Wi-Fi^{®}, Bluetooth®, and the like).

The wireless device 1002 may include a dynamic PDCP entity module 1016. The dynamic PDCP entity module 1016 may be implemented via hardware, software, or combinations thereof. For example, the dynamic PDCP entity module 1016 may be implemented as a processor, circuit, and/or instructions 1008 stored in the memory 1006 and executed by the processor(s) 1004. In some examples, the dynamic PDCP entity module 1016 may be integrated within the processor(s) 1004 and/or the transceiver(s) 1010. For example, the dynamic PDCP entity module 1016 may be implemented by a combination of software components (e.g., executed by a DSP or a general processor) and hardware components (e.g., logic gates and circuitry) within the processor(s) 1004 or the transceiver(s) 1010.

The dynamic PDCP entity module 1016 may be used for various aspects of the present disclosure, for example, aspects of FIG. 4A through FIG. 5. The dynamic PDCP entity module 1016 may configure the wireless device 1002 to use a PDCP entity in an ACTIVE state at an applicable network level and/or to manage an SCS of the UE per received instructions, etc.

The RAN device 1018 may include one or more processor(s) 1020. The processor(s) 1020 may execute instructions such that various operations of the RAN device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The RAN device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The RAN device 1018 may include one or more transceiver(s) 1026 that may include RF transmitter circuitry and/or receiver circuitry that use the antenna(s) 1028 of the RAN device 1018 to facilitate signaling (e.g., the signaling 1034) to and/or from the RAN device 1018 with other devices (e.g., the wireless device 1002) according to corresponding RATs.

The RAN device 1018 may include one or more antenna(s) 1028 (e.g., one, two, four, or more). In embodiments having multiple antenna(s) 1028, the RAN device 1018 may perform MIMO, digital beamforming, analog beamforming, beam steering, etc., as has been described.

The RAN device 1018 may include one or more interface(s) 1030. The interface(s) 1030 may be used to provide input to or output from the RAN device 1018. For example, a RAN device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto. As another example, the RAN device 1018 may communicate with the CN device 1036 on an interface 1048 of the interface(s) 1030 (which, in, for example, NR cases, may be an NG interface or in LTE cases may be an S1 interface).

The RAN device 1018 may include a dynamic PDCP entity module 1032. The dynamic PDCP entity module 1032 may be implemented via hardware, software, or combinations thereof. For example, the dynamic PDCP entity module 1032 may be implemented as a processor, circuit, and/or instructions 1024 stored in the memory 1022 and executed by the processor(s) 1020. In some examples, the dynamic PDCP entity module 1032 may be integrated within the processor(s) 1020 and/or the transceiver(s) 1026. For example, the dynamic PDCP entity module 1032 may be implemented by a combination of software components (e.g., executed by a DSP or a general processor) and hardware components (e.g., logic gates and circuitry) within the processor(s) 1020 or the transceiver(s) 1026.

The dynamic PDCP entity module 1032 may be used for various aspects of the present disclosure, for example, of FIG. 4A through FIG. 5. The dynamic PDCP entity module 1016 may configure the wireless RAN device 1018 to establish and/or use an PDCP entity for a UE radio bearer, activate a PDCP entity for the UE radio bearer, deactivate a PDCP entity for the UE radio bearer, participate in the establishment of another PDCP entity for the UE radio bearer at another network entity, etc.

The CN device 1036 may include one or more processor(s) 1038. The processor(s) 1038 may execute instructions such that various operations of the CN device 1036 are performed, as described herein. The processor(s) 1038 may include one or more baseband processors implemented using, for example, a CPU, a DSP, an ASIC, a controller, an FPGA device, another hardware device, a firmware device, or any combination thereof configured to perform the operations described herein.

The CN device 1036 may include a memory 1040. The memory 1040 may be a non-transitory computer-readable storage medium that stores instructions 1042 (which may include, for example, the instructions being executed by the processor(s) 1038). The instructions 1042 may also be referred to as program code or a computer program. The memory 1040 may also store data used by, and results computed by, the processor(s) 1038.

The CN device 1036 may include one or more interface(s) 1044. The interface(s) 1044 may be used to provide input to or output from the CN device 1036. For example, a CN device 1036 may communicate with the RAN device 1018 on an interface 1048 of the interface(s) 1044 (which, in, for example, NR cases, may be an NG interface or in LTE cases may be an S1 interface).

The CN device 1036 may include a dynamic PDCP entity module 1046. The dynamic PDCP entity module 1046 may be implemented via hardware, software, or combinations thereof. For example, the dynamic PDCP entity module 1046 may be implemented as a processor, circuit, and/or instructions 1042 stored in the memory 1040 and executed by the processor(s) 1038. In some examples, the dynamic PDCP entity module 1046 may be integrated within the processor(s) 1038. For example, the dynamic PDCP entity module 1046 may be implemented by a combination of software components (e.g., executed by a DSP or a general processor) and hardware components (e.g., logic gates and circuitry) within the processor(s) 1038.

The dynamic PDCP entity module 1016 may be used for various aspects of the present disclosure, for example, of FIG. 4A through FIG. 5. The dynamic PDCP entity module 1016 may configure the wireless CN device 1036 to establish and/or use an PDCP entity for a UE radio bearer, activate a PDCP entity for the UE radio bearer, deactivate a PDCP entity for the UE radio bearer, participate in the establishment of another PDCP entity for the UE radio bearer at another network entity, etc.

Embodiments contemplated herein include an apparatus comprising means to perform one or more elements of the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1002 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of either of the method 600 and/or the method 700. This apparatus may be, for example, an apparatus of a base station (such as a RAN device 1018 that is or is a part of a base station, as described herein) and/or of a CN (such as the CN device 1036, as described herein). It is further contemplated that this apparatus may be one of many such apparatuses working together in a distributed fashion to perform the one or more elements of the method 600.

Embodiments contemplated herein include one or more non-transitory computer-readable media comprising instructions to cause an electronic device, upon execution of the instructions by one or more processors of the electronic device, to perform one or more elements of either of the method 600 and/or the method 700. This non-transitory computer-readable media may be, for example, a memory of a base station (such as a memory 1040 of a RAN device 1018 that is or is part of a base station, as described herein) and/or of a CN (such as the memory 1040 of a CN device 1036, as described herein). It is further contemplated that the electronic device may be one of many such electronic devices working together in a distributed fashion to perform the one or more elements of the method 600.

Embodiments contemplated herein include an apparatus comprising logic, modules, or circuitry to perform one or more elements of either of the method 600 and/or the method 700. This apparatus may be, for example, an apparatus of a base station (such as a RAN device 1018 that is or is part of a base station, as described herein) and/or of a CN (such as the CN device 1036, as described herein). It is further contemplated that this apparatus may be one of many such apparatuses working together in a distributed fashion to perform the one or more elements of the method 600.

Embodiments contemplated herein include an apparatus comprising: one or more processors and one or more computer-readable media comprising instructions that, when executed by the one or more processors, cause the one or more processors to perform one or more elements of either of the method 600 and/or the method 700. This apparatus may be, for example, an apparatus of a base station (such as a RAN device 1018 that is or is part of a base station, as described herein) and/or of a CN (such as the CN device 1036, as described herein). It is further contemplated that this apparatus may be one of many such apparatuses working together in a distributed fashion to perform the one or more elements of the method 600.

Embodiments contemplated herein include a signal as described in or related to one or more elements of either of the method 600 and/or the method 700.

Embodiments contemplated herein include a computer program or computer program product comprising instructions, wherein execution of the program by a processing element is to cause the processing element to carry out one or more elements of either of the method 600 and/or the method 700. The processor may be a processor of a base station (such as a processor(s) 1020 of a RAN device 1018 that is or is part of a base station, as described herein). These instructions may be, for example, located in the processor and/or on a memory of the base station (such as a memory 1022 of a RAN device 1018 that is or is part of a base station, as described herein). The processor may be a processor of a CN device (such as a processor(s) 1038 of a CN device 1036, as described herein). These instructions may be, for example, located in the processor and/or on a memory of the CN device (such as a memory 1040 of a CN device 1036, as described herein). It is further contemplated that the processing element may be one of many such processing elements working together in a distributed fashion to perform the one or more elements of the method 600.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a network of a wireless communication system, comprising:
identifying a packet data convergence protocol (PDCP) network level change trigger for a first radio bearer of a UE served by a cluster of base stations of the wireless communication system;
determining, in response to identifying the PDCP network level change trigger for the first radio bearer, to deactivate a first PDCP entity for the first radio bearer that is at a first network level and to activate a second PDCP entity for the first radio bearer at a second network level;
instructing the first PDCP entity at the first network level to enter a sleep state; and
instructing the second PDCP entity at the second network level to enter an active state.

2. The method of claim 1, further comprising:
determining that the second PDCP entity has not yet been established at the second network level; and
duplicating the first PDCP entity into the second PDCP entity at the second network level.

3. The method of claim 2, wherein duplicating the first PDCP entity into the second PDCP entity comprises:
identifying PDCP signature attributes of a PDCP signature for the first PDCP entity; and
establishing the second PDCP entity using the PDCP signature attributes of the PDCP signature for the first PDCP entity.

4. The method of claim 3, wherein the PDCP signature attributes comprise one or more of:
configuration data for the first PDCP entity;
a PDCP entity identifier for the first PDCP entity;
a UE identifier for the UE; and
a PDCP security context for the first PDCP entity.

5. The method of claim 1, wherein:
the first network level comprises a distributed unit (DU) level and the first PDCP entity resides at a first DU of the cluster that is used by the first radio bearer; and
the second network level comprises a centralized unit (CU) level and the second PDCP entity resides at a CU of the cluster.

6. The method of claim 5, wherein the PDCP network level change trigger comprises that the UE has connected to a second DU of the cluster that is used by the first radio bearer.

7. The method of claim 5, wherein the PDCP network level change trigger comprises that a latency of a DU to DU interface between the first DU and a second DU of the cluster that is used by the first radio bearer does not meet a quality of service (QoS) requirement for the first radio bearer.

8. The method of claim 1, wherein:
the first network level comprises a centralized unit (CU) level and the first PDCP entity resides at a CU of the cluster that is used by the first radio bearer; and
the second network level comprises a distributed unit (DU) level and the second PDCP entity resides at a first DU of the cluster.

9. The method of claim 8, wherein the PDCP network level change trigger comprises that the UE has disconnected from a second DU of the cluster that is used by the first radio bearer.

10. The method of claim 8, wherein the PDCP network level change trigger comprises that a latency of a DU to DU interface between the first DU and a second DU of the cluster that is used by the first radio bearer does meets a quality of service (QoS) requirement for the first radio bearer.

11. The method of claim 1, wherein:
the first network level comprises a centralized unit (CU) level and the first PDCP entity resides at a first CU of the cluster that is used by the first radio bearer; and
the second network level comprises a core network (CN) level and the second PDCP entity resides at a CN of the wireless communication system.

12. The method of claim 11, wherein the PDCP network level change trigger comprises that the UE has connected to a second DU of the cluster that is used by the first radio bearer.

13. The method of claim 11, wherein the PDCP network level change trigger comprises that a that a latency of an Xn interface between the first CU and a second CU of the cluster that is used by the first radio bearer does not meet a quality of service (QoS) requirement for the first radio bearer.

14. The method of claim 1, wherein:
the first network level comprises a core network (CN) level and the first PDCP entity resides at a CN of the wireless communication system; and
the second network level comprises a centralized unit (CU) level and the second PDCP entity resides at a first CU of the cluster.

15. The method of claim 14, wherein the PDCP network level change trigger comprises that the UE has disconnected from a second DU of the cluster that is used by the first radio bearer.

16. The method of claim 14, wherein the PDCP network level change trigger comprises that a that a latency of an Xn interface between the first CU and a second CU of the cluster that is used by the first radio bearer meets a quality of service (QoS) requirement for the first radio bearer.

17. The method of claim 1, further comprising operating a third PDCP entity for a second radio bearer for the UE at another network level from the second network level while operating the second PDCP entity for the first radio bearer at the second network level.

18. The method of claim 1, further comprising:
establishing a new PDCP security context for the second PDCP entity that is different than an existing PDCP security context for the first PDCP entity; and
sending the new PDCP security context for the second PDCP entity to the UE.

19. The method of claim 1, further comprising synchronizing, after instructing the first PDCP entity at the first network level to enter the sleep state, the first PDCP entity with the second PDCP entity.

20. The method of claim 1, further comprising verifying, after instructing the first PDCP entity at the first network level to enter the sleep state, whether the first PDCP entity remains synchronized with the second PDCP entity.
